(19) United States
(12) Patent Application Publication
(10) Pub. No.: US 2026/0213655 A1
(43) Pub. Date: Jul. 23, 2026

(54) Multi-phase Switched-Capacitor Converter and Control Method thereof

(71) Applicant: Richtek Technology Corporation, Hsinchu (TW)

(72) Inventors: Ye-Sing LUO, Hsinchu (TW); Shui-Mu LIN, Hsinchu (TW); Hsien-Chih SHE, Hsinchu (TW); Kuo-Chi LIU, Hsinchu (TW)

(21) Appl. No.: 19/348,823

(22) Filed: Oct. 3, 2025

Related U.S. Application Data
(60) Provisional application No. 63/747,376, filed on Jan. 21, 2025.

(30) Foreign Application Priority Data
Jun. 2, 2025 (TW) 114120572

(51) Int. Cl. H02M 3/07; H02M 1/00

(52) U.S. Cl. CPC H02M 3/07; H02M 1/0043; H02M 1/0058

(57) ABSTRACT

A multi-phase switched capacitor converter is disclosed for converting a first voltage into a second voltage, or vice versa. The converter includes two sub-converters connected in parallel between an input voltage and an output voltage. Each sub-converter comprises a flying capacitor and a plurality of switches. Power conversion is performed by periodically switching the electrical connection between the flying capacitor and the voltage sources, between a first switching phase and a second switching phase. The two sub-converters alternately switch between a first system state and a second system state in a periodic manner. During the transition between the first and second system states, an overlapping system state is inserted, wherein both sub-converters are simultaneously in the first switching phase, thereby ensuring continuous current flow and reducing voltage spikes.

### CROSS REFERENCE

The present invention claims priority to US 63/747,376 filed on January 21, 2025, and claims priority to TW 114120572 filed on June 2, 2025.

### BACKGROUND OF THE INVENTION

### Field of the Invention

The present invention relates to switched-mode power conversion technologies, and more particularly, to a multi-phase switched capacitor converter and a control method thereof.

### Description of Related Art

Power converters are widely used in various application fields, including mobile devices. As constraints on size and thermal performance become increasingly stringent, the need for high efficiency and high-power density in power converter design has become more critical. To meet this demand, various architectures and control methods have been proposed in the industry to improve efficiency and reduce power loss.

For example, the prior art converter in FIG. 1 adopts non-overlapping clock control. Although it achieves multi-phase power conversion, improvements are still needed in terms of efficiency, voltage spikes, and electromagnetic interference (EMI) suppression.

### SUMMARY OF THE INVENTION

From one perspective, the present invention provides a multi-phase switched capacitor converter configured to operably convert a first voltage to a second voltage, or to convert the second voltage to the first voltage. The multi-phase switched capacitor converter comprises a first sub-converter and a second sub-converter, coupled in parallel between the first voltage and the second voltage; wherein each of the first sub-converter and the second sub-converter includes a flying capacitor, and a plurality of switches configured to periodically switch electrical connections between the flying capacitor and the first and second voltages during a first switching phase and a second switching phase; wherein during the first switching phase, the flying capacitor is electrically connected to the first voltage via the switching of the plurality of switches, forming a current path; wherein during the second switching phase, the flying capacitor is electrically disconnected from the first voltage via the switching of the plurality of switches; wherein the multi-phase switched capacitor converter periodically alternates between a first system state and a second system state to perform power conversion between the first voltage and the second voltage; wherein in the first system state, the first sub-converter is in the first switching phase and the second sub-converter is in the second switching phase; wherein in the second system state, the first sub-converter is in the second switching phase and the second sub-converter is in the first switching phase; wherein a transition from the first system state to the second system state or from the second system state to the first system state includes an overlapping system state such that a first current corresponding to the first voltage is maintained to avoid a voltage spike; wherein in the overlapping system state, both the first sub-converter and the second sub-converter are in the first switching phase.

In one embodiment, a duration of the overlapping system state is less than 25% of a switching period of the multi-phase switched capacitor converter.

In one embodiment, each of the first sub-converter and the second sub-converter is configured to transition from the first switching phase to the second switching phase, or from the second switching phase to the first switching phase, via a dead time.

In one embodiment, upon entering the first switching phase or the second switching phase, each of the first sub-converter and the second sub-converter is configured to switch a first terminal of the flying capacitor earlier than a second terminal of the flying capacitor to electrically connect the first terminal to a node corresponding to the first switching phase, such that the second terminal gradually approaches a zero-voltage state before being subsequently switched to electrically connect to a corresponding node in the first switching phase, thereby achieving zero-voltage switching (ZVS); wherein under steady-state operation, a terminal of the flying capacitor having a lower voltage corresponds to the first terminal; and/or a terminal of the flying capacitor exhibiting a lower terminal-phase voltage difference corresponds to the first terminal; wherein the terminal-phase voltage difference refers to an absolute value of a voltage level difference at each terminal of the flying capacitor between the first switching phase and the second switching phase.

In one embodiment, each of the first sub-converter and the second sub-converter includes a plurality of flying capacitors, wherein in the first switching phase, the plurality of flying capacitors sequentially complete corresponding electrical connections such that voltage transitions of both the first terminal and the second terminal of each of the plurality of flying capacitors increase progressively; and/or in the second switching phase, the plurality of flying capacitors sequentially complete corresponding electrical connections such that voltage transitions of both the first terminal and the second terminal of each of the plurality of flying capacitors decrease progressively.

In one embodiment, upon entering the first switching phase or the second switching phase, the first terminal of the flying capacitor is switched, via zero-current switching, to electrically connect to a corresponding node.

In one embodiment, the plurality of switches includes a first switch, a second switch, a third switch, and a fourth switch, and wherein the first switch is coupled between the first voltage and the second terminal of the flying capacitor; the second switch is coupled between a first terminal of the flying capacitor and the second voltage; the third switch is coupled between the second terminal of the flying capacitor and the second voltage; and the fourth switch is coupled between the first terminal of the flying capacitor and a ground potential; wherein in the first switching phase, the first switch and the second switch are turned on to electrically connect the flying capacitor between the first voltage and the second voltage, such that the first voltage charges the flying capacitor and supplies power to the second voltage; wherein in the second switching phase, the third switch and the fourth switch are turned on to electrically connect the flying capacitor in parallel with the second voltage, such that the flying capacitor discharges to supply power to the second voltage.

In one embodiment, the first switch is turned on after a predetermined delay following the second switch being turned on to achieve zero-voltage switching; and/or the third switch is turned on after a predetermined delay following the fourth switch being turned on to achieve zero-voltage switching; or after the second switch is turned on, the first switch is turned on when a voltage across the first switch is below a threshold, to achieve zero-voltage switching; and/or after the fourth switch is turned on, the third switch is turned on when a voltage across the third switch is below a threshold, to achieve zero-voltage switching.

In one embodiment, a voltage conversion ratio between the first voltage and the second voltage is 2:1.

In one embodiment, a voltage conversion ratio between the first voltage and the second voltage is K:1, wherein each of the first sub-converter and the second sub-converter corresponds to a series-parallel switched capacitor converter comprising a plurality of flying capacitors, and K is a positive integer greater than or equal to 3.

In one embodiment, a voltage conversion ratio between the first voltage and the second voltage is K:1, wherein each of the first sub-converter and the second sub-converter corresponds to a pipelined switched capacitor converter or a Dickson switched capacitor converter, and K is a positive integer greater than or equal to 4.

In one embodiment, an equivalent inductance is included between the first voltage and the flying capacitor, and the equivalent inductance causes the voltage spike when the first current is discontinued.

From another perspective, the present invention provides a control method for use in power conversion between a first voltage and a second voltage, comprising controlling each of two sub-converter units to periodically switch between a first switching phase and a second switching phase, wherein during the first switching phase, a flying capacitor is electrically connected to the first voltage to form a current path toward the second voltage, and during the second switching phase, the flying capacitor is disconnected from the first voltage; controlling the two sub-converter units to periodically switch between a first system state and a second system state, wherein the first system state corresponds to one of the two sub-converter units being in the first switching phase and the other one of the two sub-converter units being in the second switching phase, and the second system state is inverse to the first system state; and transitioning between the first system state and the second system state via an overlapping system state, during which both of the sub-converter units are in the first switching phase simultaneously, so as to maintain continuity of a first current corresponding to the first voltage to avoid a voltage spike.

In one embodiment, the step of controlling each of the sub-converter units to periodically switch between the first switching phase and the second switching phase includes inserting a dead time between the first switching phase and the second switching phase for each of the sub-converter units, so as to prevent short-circuit current among switching elements within each of the sub-converter units.

In one embodiment, the step of controlling each of the sub-converter units to periodically switch between the first switching phase and the second switching phase includes, upon entering the first switching phase, electrically connecting a first terminal of the flying capacitor to a corresponding node earlier than electrically connecting a second terminal of the flying capacitor to a corresponding node, such that the second terminal gradually approaches a zero-voltage state before being switched, thereby achieving zero-voltage switching (ZVS); wherein under steady-state operation, a terminal of the flying capacitor having a lower voltage corresponds to the first terminal; and/or a terminal of the flying capacitor exhibiting a lower terminal-phase voltage difference corresponds to the first terminal; wherein the terminal-phase voltage difference refers to an absolute value of a voltage level difference at each terminal of the flying capacitor between the first switching phase and the second switching phase.

In one embodiment, each of the sub-converter units includes a plurality of flying capacitors, and the step of controlling each of the sub-converter units to periodically switch between the first switching phase and the second switching phase further includes, in the first switching phase, sequentially completing corresponding electrical connections of the plurality of flying capacitors to corresponding nodes such that voltage transitions of both the first terminal and the second terminal of each of the plurality of flying capacitors increase progressively; and in the second switching phase, completing corresponding electrical connections of the plurality of flying capacitors to corresponding nodes such that voltage transitions at the first and second terminals of each flying capacitor decrease progressively.

The present invention provides a multi-phase switched capacitor converter in which a controller interleaves the operating phases of multiple converter units and periodically transitions through an overlapping system state. The present invention simultaneously enables the following advantages: reduced voltage spikes and ripple at the input and output ends, extended converter lifespan, improved electromagnetic interference (EMI) performance, realization of zero-voltage switching (ZVS) and zero-current switching (ZCS) for enhanced efficiency and thermal performance, and support for higher power conversion requirements.

The objectives, technical details, features, and effects of the present invention will be better understood with regard to the detailed description of the embodiments below, with reference to the attached drawings.

### BRIEF DESCRIPTION OF THE DRAWINGS

FIG. 1 illustrates a circuit schematic and control signal waveforms of a multi-phase switched capacitor converter according to prior art.

FIG. 2 illustrates a schematic diagram of a multi-phase switched capacitor converter according to an embodiment of the present invention.

FIG. 3 illustrates a schematic diagram of a specific embodiment of a controller corresponding to FIG. 2.

FIG. 4 illustrates control signal waveforms corresponding to FIG. 2.

FIG. 5A illustrates a switching state diagram of an overlapping system state corresponding to FIG. 2.

FIG. 5B illustrates a first switching state diagram of a first system state corresponding to FIG. 2.

FIG. 5C illustrates a second switching state diagram of a second system state corresponding to FIG. 2.

FIG. 6A illustrates input and output current waveforms under a non-overlapping control scheme according to prior art.

FIG. 6B illustrates input and output current waveforms under the control scheme of the present invention.

FIG. 7 illustrates switching control signal waveforms and a phase transition sequence diagram according to an embodiment of the present invention.

FIG. 8 illustrates a circuit configuration diagram of a 4:1 series-parallel architecture according to an embodiment of the present invention.

FIG. 9 illustrates a circuit configuration diagram of a 4:1 pipelined architecture according to an embodiment of the present invention.

FIG. 10 illustrates a circuit configuration diagram of a 4:1 Dickson architecture according to an embodiment of the present invention.

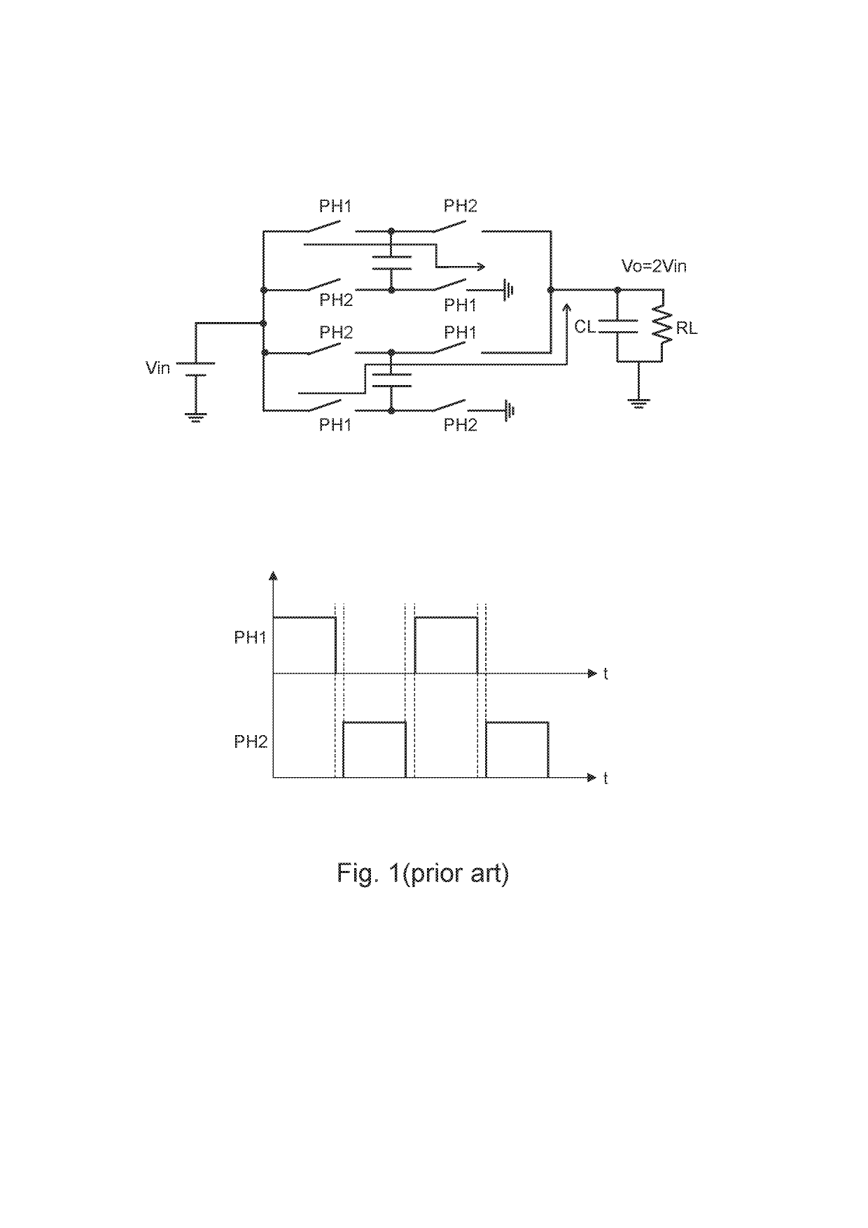

### DESCRIPTION OF THE EMBODIMENTS

The drawings as referred to throughout the description of the present invention are for illustration only, to show the interrelations between the circuits and the signal waveforms, but not drawn according to actual scale of circuit sizes and signal amplitudes and frequencies.

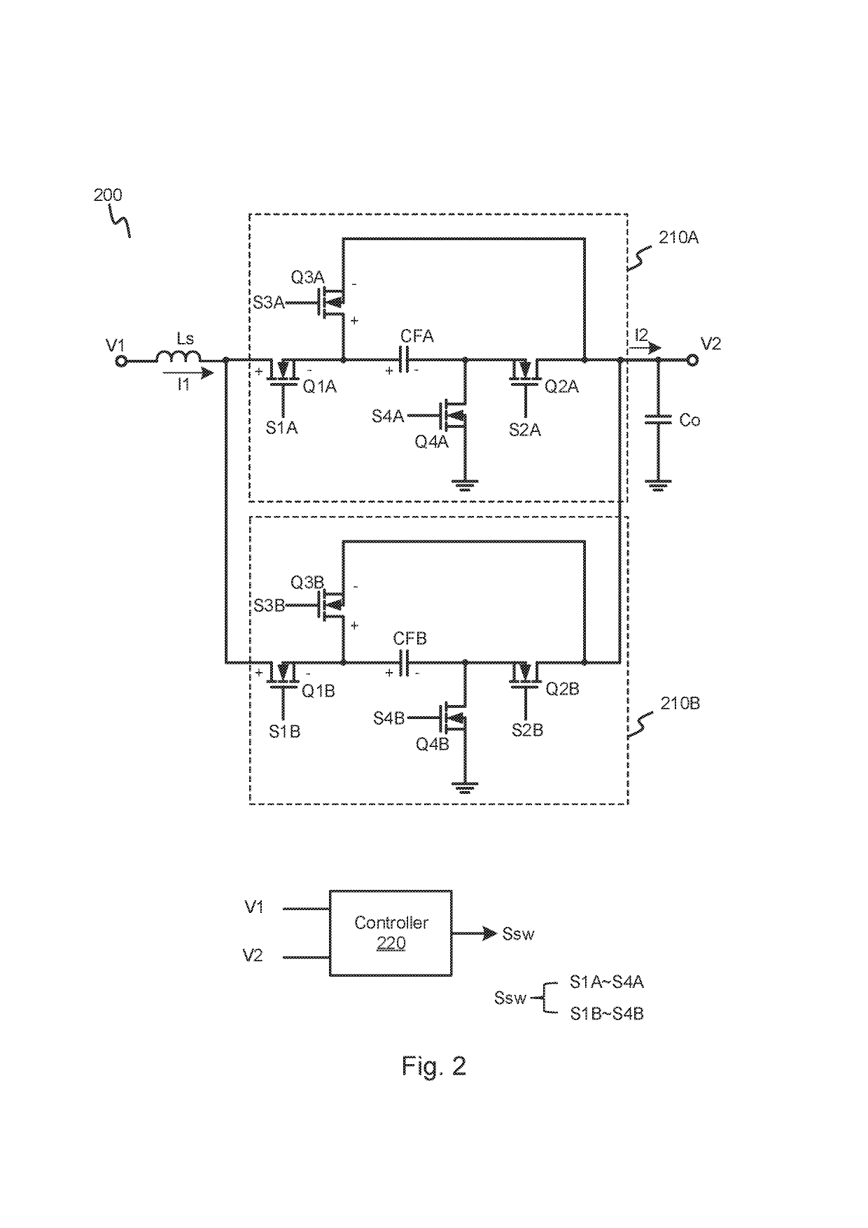

FIG. 2 illustrates a schematic diagram of a multi-phase switched capacitor converter according to an embodiment of the present invention. The multi-phase switched capacitor converter 200 includes a first sub-converter 210A and a second sub-converter 210B, which are coupled in parallel between a first voltage V1 and a second voltage V2. In the present embodiment, each of the sub-converters is a step-down switched capacitor converter, having a voltage conversion ratio of 2:1, comprising a flying capacitor (i.e., CFA or CFB) and a plurality of switches (i.e., Q1A–Q4A or Q1B–Q4B). By periodically switching the switches, the first voltage V1 is converted to the second voltage V2, thereby forming a 2:1 switched capacitor voltage divider.

The multi-phase switched capacitor converter 200 further comprises a controller 220 configured to generate switching control signals Ssw to control the operations of the first sub-converter 210A and the second sub-converter 210B. The first sub-converter 210A switches between a first switching phase PH1A and a second switching phase PH2A, where a plurality of switches periodically switch the electrical connection of its internal flying capacitor between the first voltage V1 and the second voltage V2 for power conversion. Similarly, the second sub-converter 210B operates between a corresponding first switching phase PH1B and a corresponding second switching phase PH2B.

As shown in FIG. 2, an equivalent inductance Ls represents the total of the power source impedance, PCB trace inductance, and parasitic inductance of the wiring at the input end (corresponding to the first voltage V1 in this embodiment). If the input current (the first current I1 in this embodiment, corresponding to V1) is interrupted to be discontinued, a high-voltage spike may be generated, which could damage the switches.

In one embodiment, the first sub-converter 210A and the second sub-converter 210B are substantially switched in inverse phases. However, the present invention proposes a more refined switching scheme to suppress voltage spikes at the input voltage (e.g., the first voltage V1 in this embodiment).

In the overall operation of the multi-phase switched capacitor converter 200, the controller 220 periodically switches the multi-phase switched capacitor converter 200 between a first system state, an overlapping system state, and a second system state. In the first system state, the first sub-converter 210A is in its first switching phase PH1A, while the second sub-converter 210B is in its second switching phase PH2B. In the second system state, the first sub-converter 210A is in its second switching phase PH2A, and the second sub-converter 210B is in its first switching phase PH1B. In the overlapping system state, both sub-converters are in their respective first switching phases PH1A and PH1B.

In one embodiment, before switching into either the first system state or the second system state, the converter first enters the overlapping system state. This embodiment establishes a continuous current path between the input voltage and the sub-converters, ensuring uninterrupted and thus continuous first current I1, effectively suppressing voltage spikes, consequently improving the reliability, EMI performance, and lifespan of the converter, and reducing the electrical stress on the switching elements and thus lowering cost.

The detailed circuit operations and switching actions associated with the aforementioned first switching phase and second switching phase will be described in subsequent paragraphs.

It should be noted that the embodiments of the multi-phase switched capacitor converter disclosed herein are primarily described with respect to power conversion from the first voltage V1 to the second voltage V2 (i.e., V1 serves as the input voltage and V2 as the output voltage, where the first current I1 corresponds to the input current and the second current I2 corresponds to the output current). In other embodiments, the disclosed converter may also support reverse power conversion from the second voltage V2 to the first voltage V1.

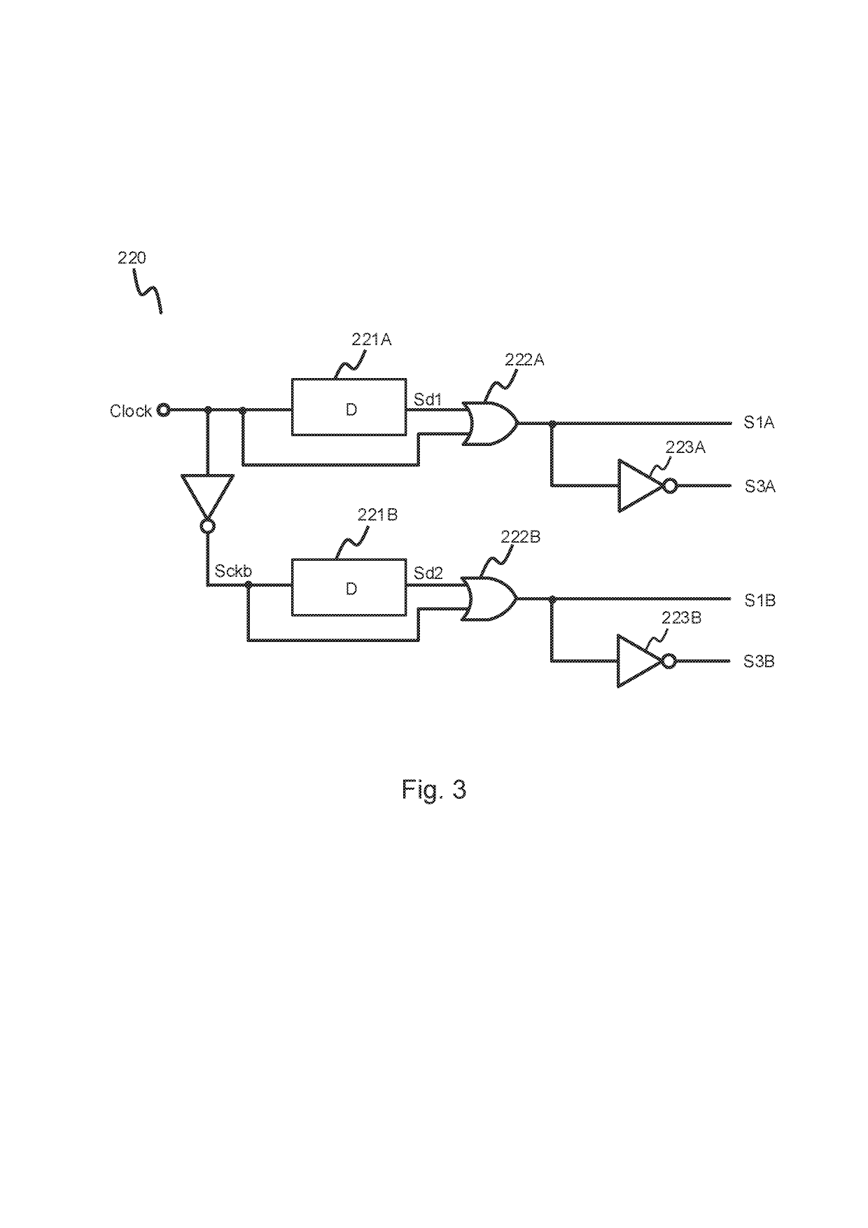

FIG. 3 illustrates a schematic diagram of a specific embodiment of the controller according to the present invention. The controller 220 includes a first OR gate 222A and a second OR gate 222B. The first OR gate 222A receives a clock signal Clock and a delayed clock signal Sd1, and outputs a first switch control signal S1A and a third switch control signal S3A for the first sub-converter 210A via an inverter 223A. The second OR gate 222B receives an inverted clock signal Sckb and a delayed inverted clock signal Sd2, and outputs a first switch control signal S1B and a third switch control signal S3B for the second sub-converter 210B via an inverter 223B, thereby enabling the multi-phase switched capacitor converter 200 to periodically switch between the aforementioned system states. The delayed clock signals Sd1 and Sd2 are generated by delaying the clock signal Clock and the inverted clock signal Sckb using delay elements 221A and 221B, respectively.

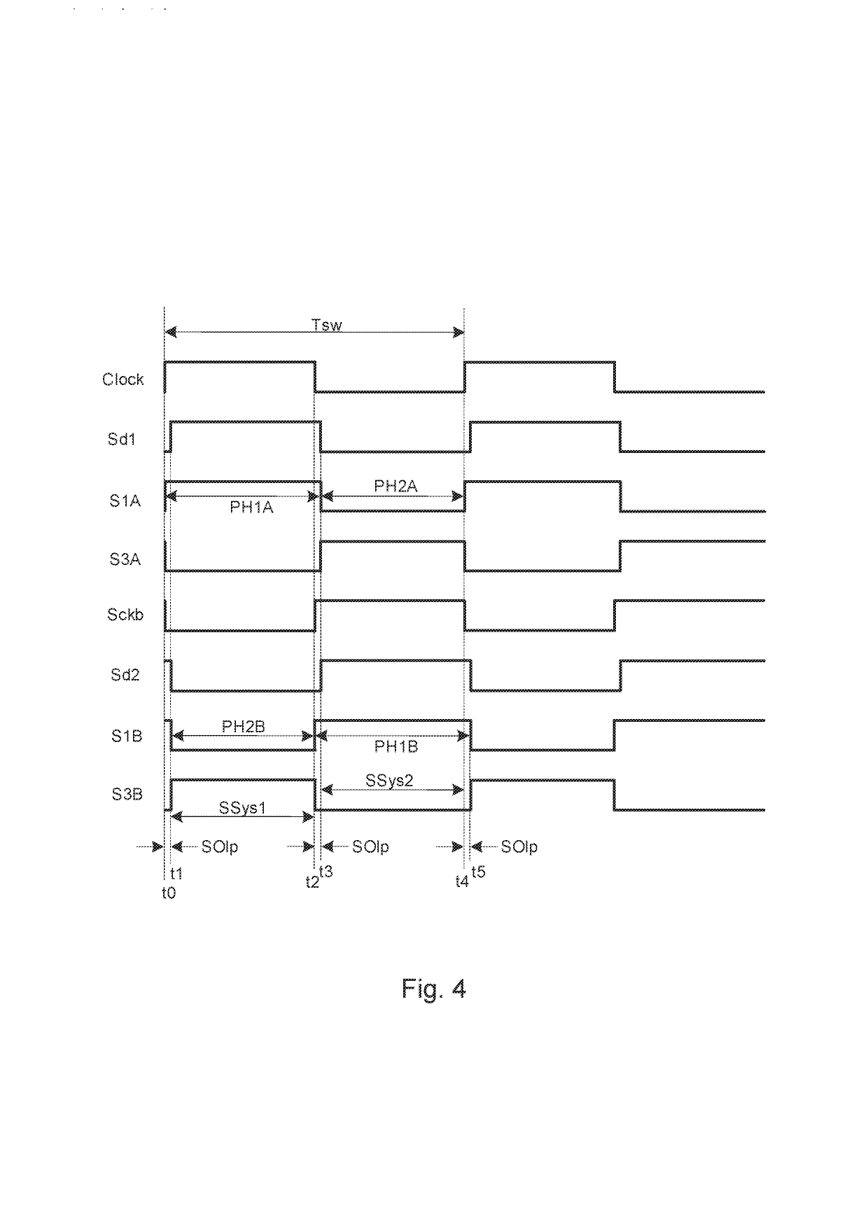

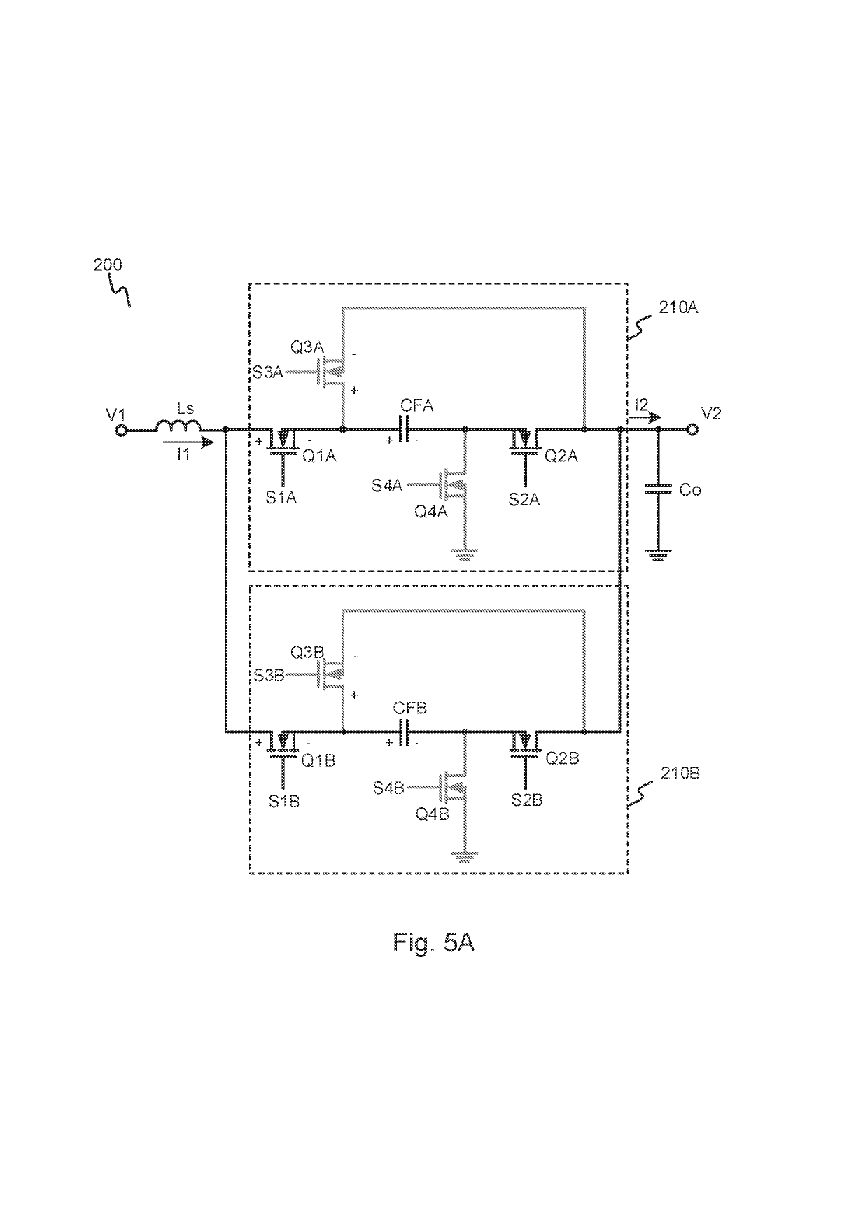

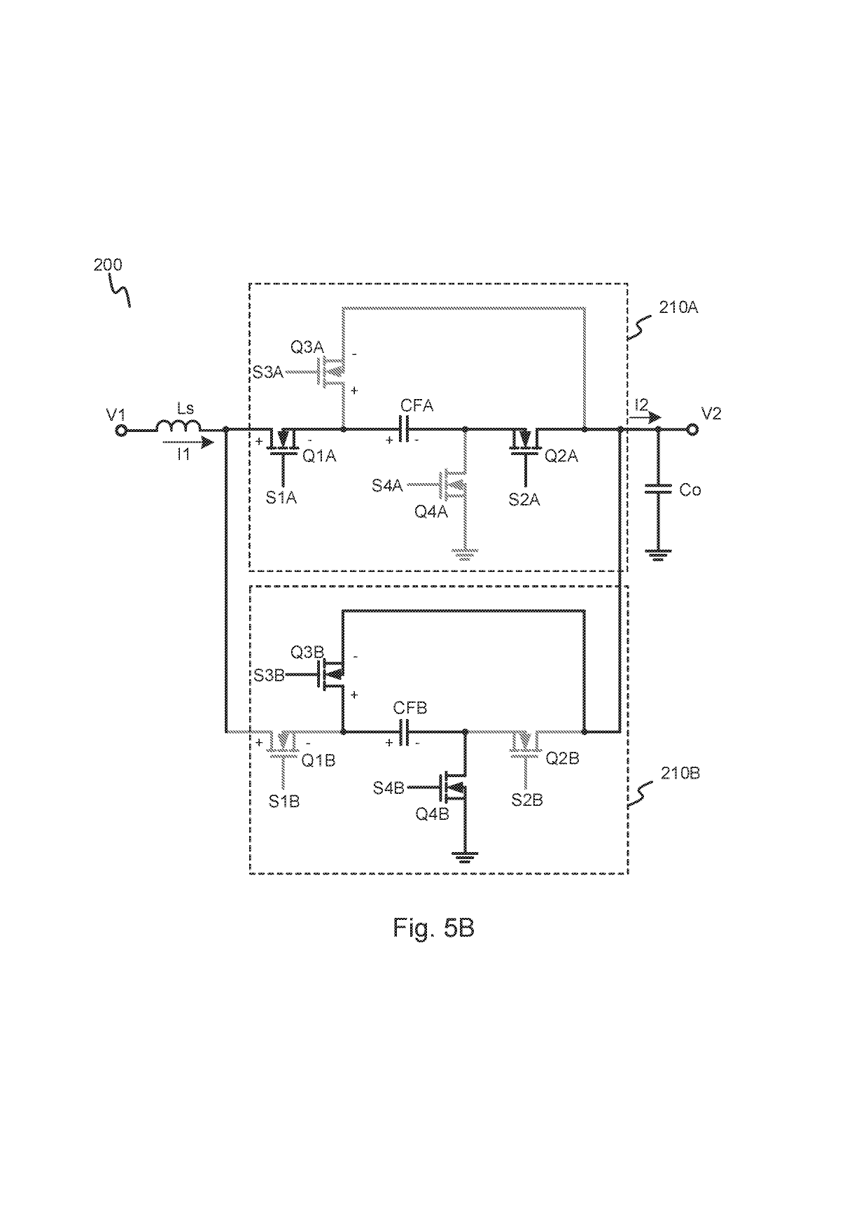

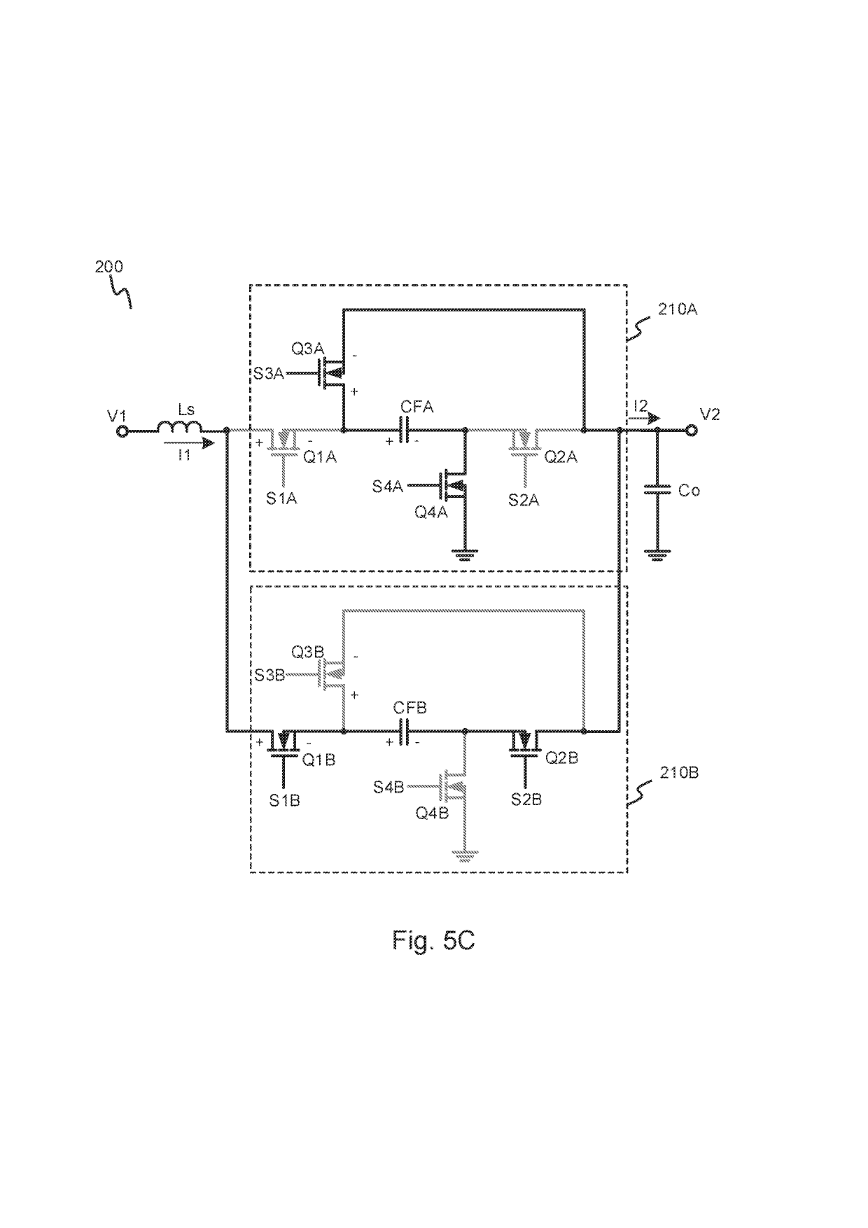

FIG. 4 and FIGS. 5A–5C collectively illustrate the operating states and corresponding circuit switching operations of the multi-phase switched capacitor converter 200 within a switching period according to one embodiment of the present invention. FIG. 4 shows a waveform diagram of control signals corresponding to FIG. 2, while FIGS. 5A to 5C illustrate the switching states of the circuit in different system states corresponding to FIG. 2.

In the present embodiment, the first sub-converter 210A operates in its first switching phase PH1A during the time interval t0–t3, and transitions to the second switching phase PH2A during t3–t4. The second sub-converter 210B operates in its second switching phase PH2B during t1–t2, and in its first switching phase PH1B during t2–t5. A switching period is illustrated by Tsw (from t0 to t4).

The first and second switching phases of each sub-converter correspond to different electrical connections between the flying capacitor and the first voltage V1, the second voltage V2, or ground potential. Specifically, in the first switching phase PH1A or PH1B, the flying capacitor (CFA or CFB) is electrically connected between V1 and V2 via conduction of the first and second switches (Q1A and Q2A, or Q1B and Q2B). In the first switching phase, the first voltage V1 supplies power to the second voltage V2 through the corresponding flying capacitor, while simultaneously charging the flying capacitor. In the second switching phase PH2A or PH2B, the corresponding flying capacitor is connected in parallel with the second voltage V2 through the conduction of the third and fourth switches (Q3A and Q4A, or Q3B and Q4B) to supply charge stored in the flying capacitor to V2.

From a system-level perspective, the multi-phase switched capacitor converter 200 is periodically switched between a first system state SSys1, an overlapping system state SOlp, and a second system state SSys2 for performing power conversion between the first voltage V1 and the second voltage V2. In the first system state SSys1, the first sub-converter 210A is in its first switching phase PH1A, and the second sub-converter 210B is in its second switching phase PH2B. In the second system state SSys2, the first sub-converter 210A is in its second switching phase PH2A, and the second sub-converter 210B is in its first switching phase PH1B.

According to the present invention, when the multi-phase switched capacitor converter 200 transitions from the first system state SSys1 to the second system state SSys2, or transitions from the second system state SSys2 to the first system state SSys1, the overlapping system state SOlp is inserted between the transition to ensure continuity of the first current I1, thereby preventing voltage spikes. In the overlapping system state SOlp, both sub-converters 210A and 210B are in their respective first switching phases PH1A and PH1B.

The waveforms and electrical connection states associated with the switching phases and system state transitions described above are detailed with reference to FIG. 4 and FIGS. 5A–5C.

First system state (SSys1): As shown in FIG. 4, during the interval t1–t2, the switching states correspond to those in FIG. 5B. At this time, the first sub-converter 210A is in its first switching phase PH1A, and the second sub-converter 210B is in its second switching phase PH2B. In this state, the flying capacitor CFA of the first sub-converter 210A is electrically connected between the first voltage V1 and the second voltage V2 via conduction of the first and second switches (Q1A and Q2A), thereby allowing the first voltage V1 to supply power to the second voltage V2 through CFA, and to simultaneously charge CFA. Simultaneously, the flying capacitor CFB of the second sub-converter 210B is connected in parallel with V2 via conduction of the third and fourth switches (Q3B and Q4B) to supply power to the second voltage V2 using the charge stored in the flying capacitor CFB. It is noted that switches turned off in the corresponding states are shown in gray in the figures, and the same applies to subsequent illustrations.

Overlapping system state (SOlp): As shown in FIG. 4, during t2–t3 (and likewise during t4–t5), the switching states correspond to those in FIG. 5A. In the overlapping system state SOlp, both sub-converters 210A and 210B are in their respective first switching phases PH1A and PH1B. At this time, both CFA and CFB are electrically connected between V1 and V2 via their respective first and second switches (i.e., Q1A, Q2A; and Q1B, Q2B), forming dual current paths. The first voltage V1 supplies power to the second voltage V2 via both CFA and CFB, thereby effectively maintaining the continuity of the first current I1 and suppressing voltage spikes.

Second system state (SSys2), being transitioned subsequently: As shown in FIG. 4, during t3–t4, the switching states correspond to those in FIG. 5C. At this point, the first sub-converter 210A is in its second switching phase PH2A, and the second sub-converter 210B is in its first switching phase PH1B. The specific electrical connection relationships are inverse to those in the first system state SSys1.

Since transitions between the first system state SSys1 and the second system state SSys2 always pass through the overlapping system state SOlp (i.e., during t0–t1, t2–t3, and t4–t5), it is ensured that at any given moment, the first voltage V1 remains electrically connected to at least one flying capacitor, maintaining a current path. This further guarantees the continuity of the first current I1, thereby preventing voltage spikes caused by the equivalent inductance Ls. In one embodiment, the duration of the overlapping system state SOlp is for example less than 25% of the switching period Tsw of the multi-phase switched capacitor converter.

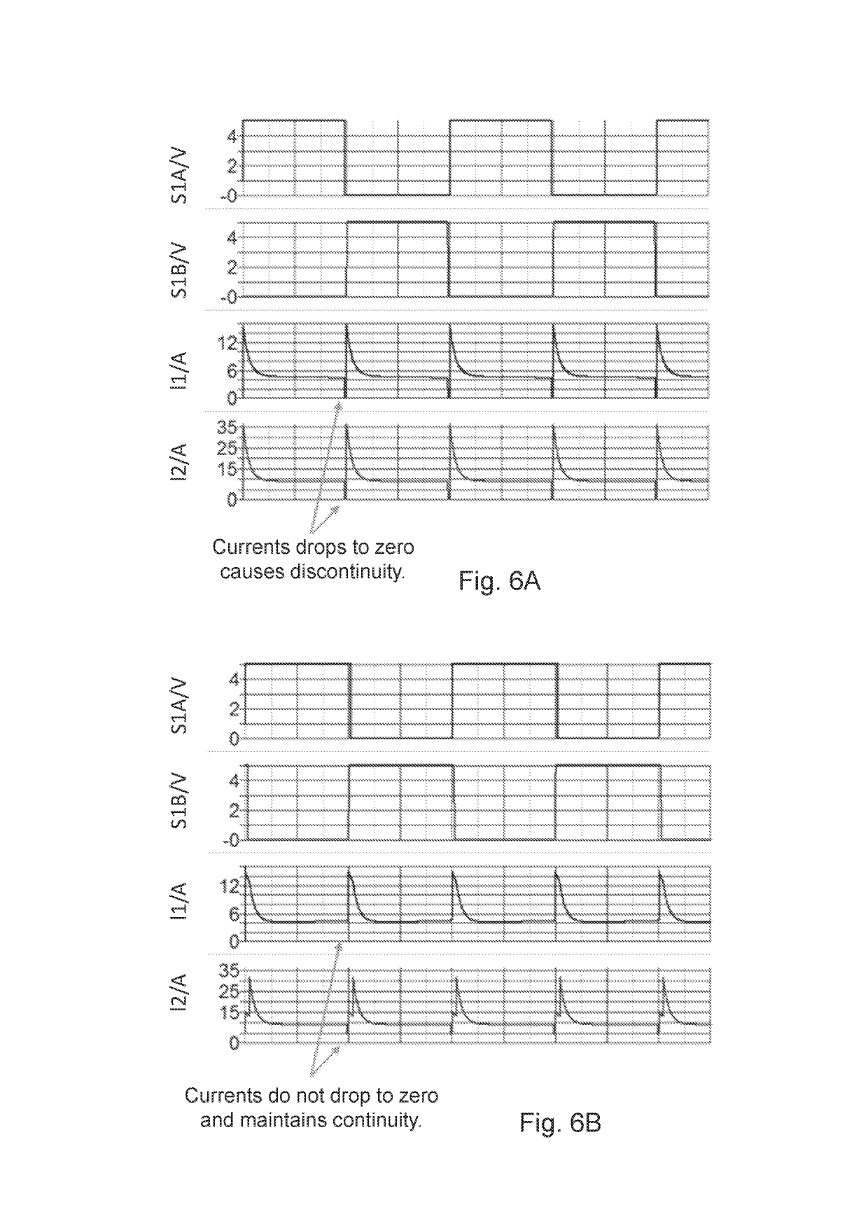

FIGS. 6A and 6B illustrate simulated waveforms showing the impact of different control methods on the input and output currents of the multi-phase switched capacitor converter 200. In a non-overlapping control method (FIG. 6A), when the first sub-converter 210A and the second sub-converter 210B perform system-level phase transitions (e.g., from SSys1 to SSys2), a dead time exists during which neither converter is in the first switching phase. This results in discontinuity of the first current I1 (input current) and the second current I2 (output current), causing them to drop to zero. Consequently, voltage spikes are generated due to the effect of the equivalent inductance Ls, and such high-voltage spikes may damage the switching elements.

In contrast, when the control method of the present invention is applied (as shown in FIG. 6B), an overlapping system state SOlp is inserted between the first system state SSys1 and the second system state SSys2, such that the first sub-converter 210A and the second sub-converter 210B are both operated in their respective first switching phases PH1A and PH1B during this time interval. Flying capacitors CFA and CFB are simultaneously electrically connected between the first voltage V1 and the second voltage V2, forming a parallel dual power-supply path that supplies power from the first voltage V1 to the second voltage V2. This ensures that the first current I1 and the second current I2 do not experience discontinuity (i.e., do not return to zero). Simulation waveforms show that under this control mechanism, both currents I1 and I2 remain continuous, thereby preventing high-frequency voltage spikes, improving overall electromagnetic compatibility, and extending the operating lifetime of converter components or reducing associated costs.

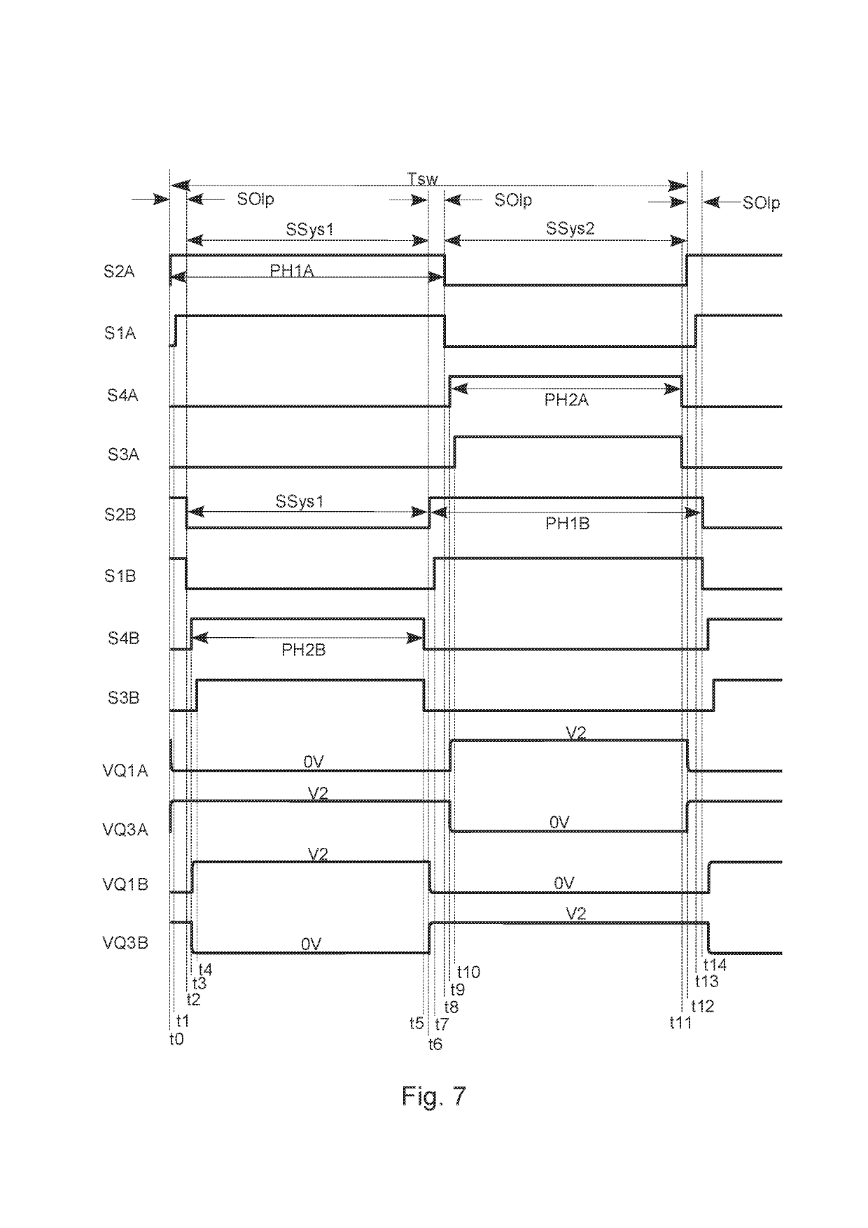

FIG. 7 illustrates the control signal waveforms within one switching period of the multi-phase switched capacitor converter 200 according to one embodiment of the present invention. This figure shows the phase switching sequence of the first sub-converter 210A and the second sub-converter 210B and their correlation with system states, and further depicts the turn-on sequence and the operation of zero-voltage switching (ZVS) and zero-current switching (ZCS).

In the switching period shown in FIG. 7, the first switching phase PH1A of the first sub-converter 210A corresponds to the interval from t0 to t8, and its second switching phase PH2A corresponds to t9 to t11. During PH1A, control signal S2A is pulled high at t0 to turn on switch Q2A. Subsequently, when the voltage across switch Q1A (V1 - VCFA - V2) approaches zero, control signal S1A turns on Q1A at t1 under ZVS conditions, where VCFA denotes the voltage across flying capacitor CFA. The flying capacitor CFA is electrically connected between the first voltage V1 and the second voltage V2 from t1 to t8 to perform power transfer and charging. The interval from t8 to t9 is a dead time between PH1A and PH2A to prevent shoot-through current caused by short-circuit conduction between low-impedance power rails. During the second switching phase PH2A starting at t9, control signal S4A turns on switch Q4A, and at t10, switch Q3A is turned on under ZVS conditions when the voltage across Q3A (VCFA - V2) equals zero, completing operation in the second switching phase PH2A. During the second switching phase PH2A, the flying capacitor CFA is connected in parallel to the second voltage V2 to supply power thereto. The interval from t11 to t12 is also a dead time between switching phases.

The second switching phase PH2B of the second sub-converter 210B corresponds to the interval from t3 to t5, and the first switching phase PH1B corresponds to the interval from t6 to t14. After the end of PH2B, the interval from t5 to t6 is a dead time. During the first switching phase PH1B, control signal S2B turns on switch Q2B at t6, and at t7, when the voltage across Q1B (Vin - VCFB - Vout) equals zero, Q1B is turned on by control signal S1B under ZVS conditions. The flying capacitor CFB is electrically connected between V1 and V2 from t7 to t14 to perform power transfer and charging. Similarly, at the beginning of the second switching phase PH2B, switch Q4B is turned on at t3, followed by Q3B being turned on at t4 under ZVS conditions, completing the operation of the second switching phase PH2B, in which the flying capacitor CFB is connected in parallel to V2 to supply power thereto.

In the above switching phase turn-on sequences, the mentioned delay times (e.g., t0 to t1, t9 to t10, t6 to t7, and t3 to t4) can be predetermined fixed delays in one embodiment of the present invention. These fixed delay times may be determined based on circuit parameters to ensure that, after the delay, the voltage across the to-be-turned-on switch (e.g., Q1A or Q3A) has dropped to or near zero, achieving ZVS. In another embodiment, the delay time may be adaptively adjusted by the controller based on actual measurements, for example, by detecting whether the voltage across the switch (e.g., Q1A or Q3B) has fallen below a predetermined threshold before turning it on, thereby further improving efficiency.

In one embodiment, the aforementioned switching order can be selected based on the steady-state voltage across the flying capacitor. Specifically, in one embodiment, the terminal of the flying capacitor with the lower steady-state voltage may be switched first to its corresponding node. After the aforementioned delay time, the other terminal may subsequently be switched to its corresponding electrical connection under ZVS conditions.

At the system level of the multi-phase switched capacitor converter, as shown in FIG. 7, the operation includes several system state transitions as described above. The first system state SSys1 occurs between t2 and t6, during which the first sub-converter 210A is in its first switching phase PH1A, while the second sub-converter 210B is in its second switching phase PH2B. The second system state SSys2 occurs between t8 and t12, during which the first sub-converter 210A is in its second switching phase PH2A, and the second sub-converter 210B is in its first switching phase PH1B. The overlapping system state SOlp occurs during t0 to t2, t6 to t8, and t12 to t14, where both sub-converters are in their respective first switching phases (PH1A and PH1B). During the overlapping system state SOlp, the flying capacitors CFA and CFB are connected in parallel between V1 and V2 to maintain current continuity and suppress voltage spikes during the transition between SSys1 and SSys2.

It is noteworthy that the waveform shown in FIG. 7 also reveals that although there is no dead time at the system level (i.e., during the interleaved switching of the sub-converters), dead times are still implemented between the switching phases of individual sub-converters (e.g., t8 to t9, t11 to t12, t2 to t3, and t5 to t6). During these dead times, all switches in all sub-converters are turned off to prevent short-circuit currents.

In this embodiment, the first switches Q1A and Q1B and the third switches Q3A and Q3B are turned on only when the voltage across them has dropped to zero, thereby realizing zero-voltage switching. On the other hand, the second switches Q2A and Q2B and the fourth switches Q4A and Q4B are turned on when the current approaches zero, achieving zero-current switching and effectively reducing switching losses.

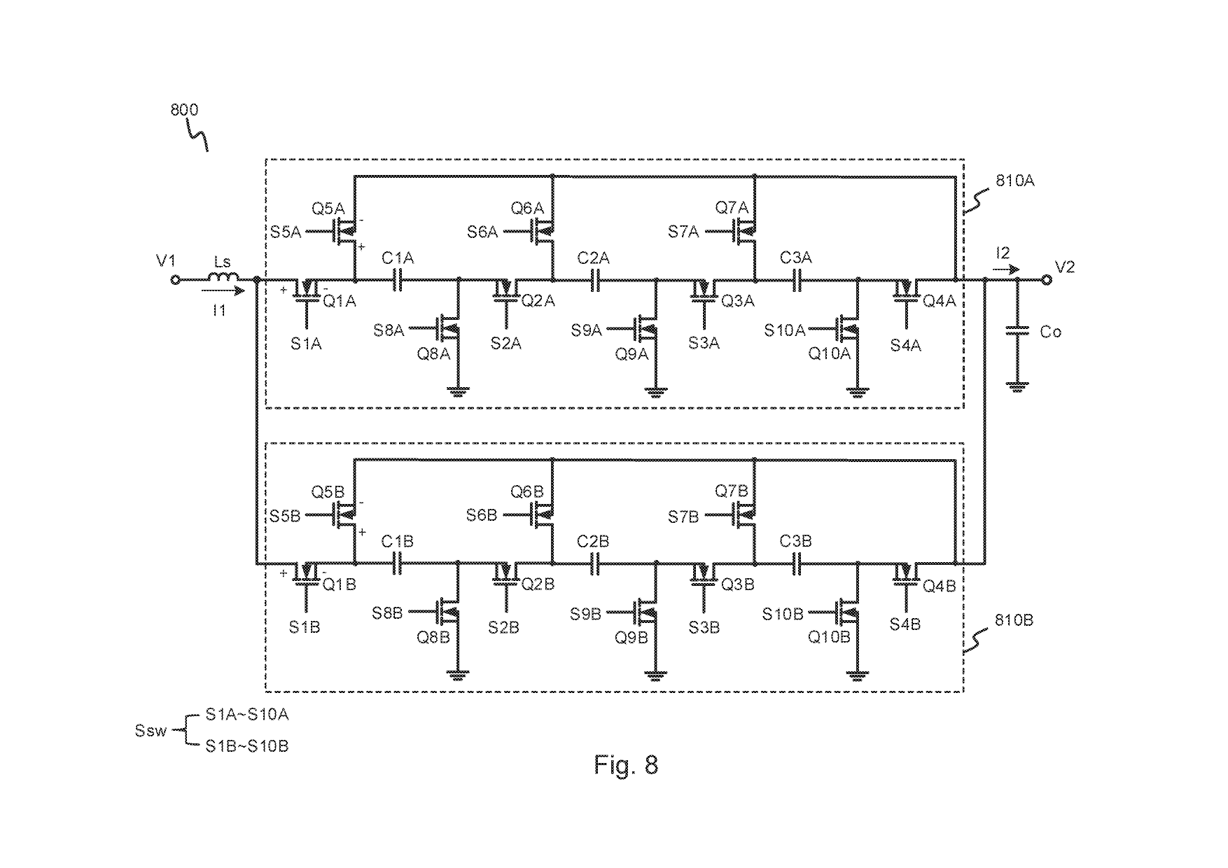

FIG. 8 shows the circuit configuration of a multi-phase switched capacitor converter 200 in a series-parallel structure, having a voltage conversion ratio of 4:1, according to one embodiment of the present invention. The multi-phase switched capacitor converter 800 includes a first sub-converter 810A and a second sub-converter 810B, connected in parallel between the first voltage V1 and the second voltage V2. Each of the sub-converters 810A and 810B corresponds to a 4:1 series-parallel switched capacitor converter and includes three flying capacitors (C1A–C3A, C1B–C3B) and a plurality of switches. These flying capacitors are switched between series and parallel configurations to achieve a 4:1 voltage conversion ratio.

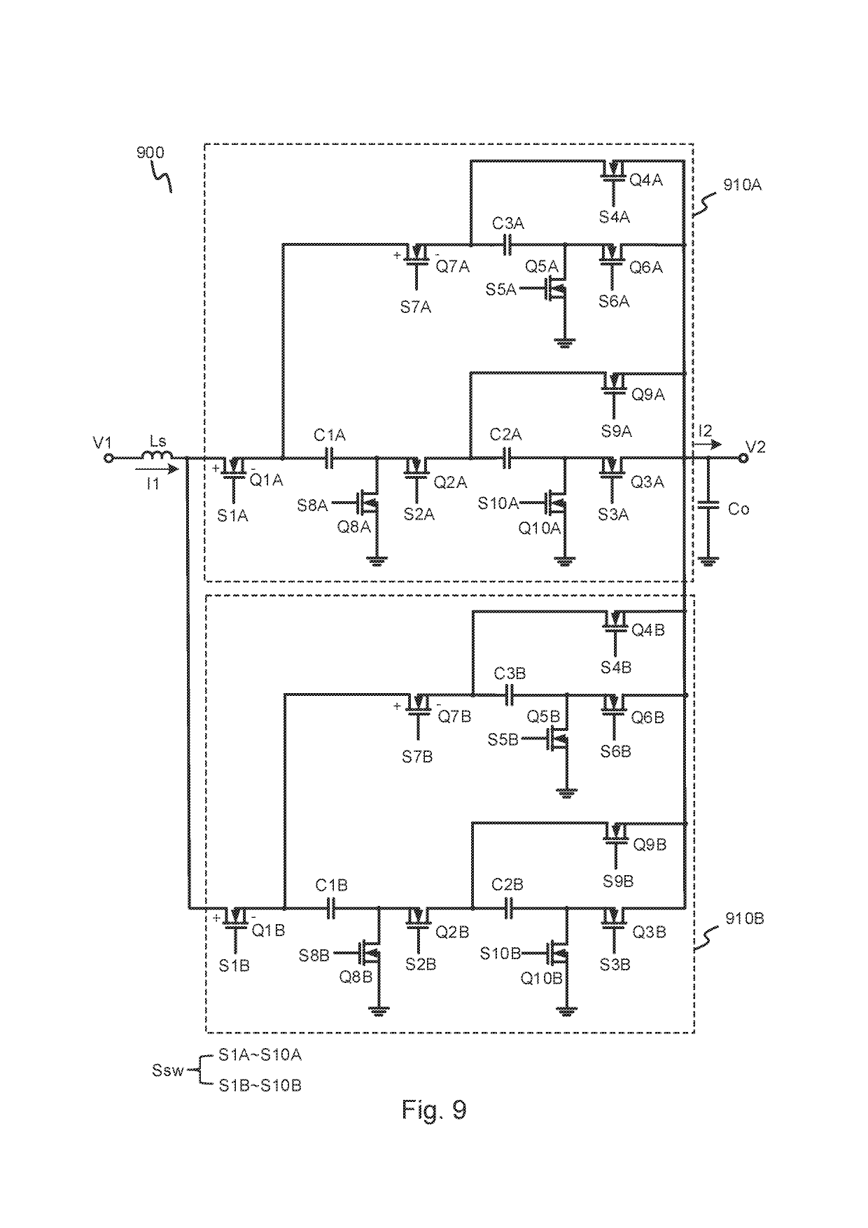

FIG. 9 illustrates the circuit configuration of a multi-phase switched capacitor converter 900 in a pipeline architecture, having a voltage conversion ratio of 4:1, according to another embodiment of the present invention. Similar to the previous embodiment, the multi-phase switched capacitor converter 900 includes a first sub-converter 910A and a second sub-converter 910B, which are connected in parallel between a first voltage V1 and a second voltage V2. Each of the sub-converters includes three flying capacitors (C1A–C3A, C1B–C3B) and a plurality of switches. Through a progressive voltage division approach, a 4:1 voltage conversion ratio is achieved.

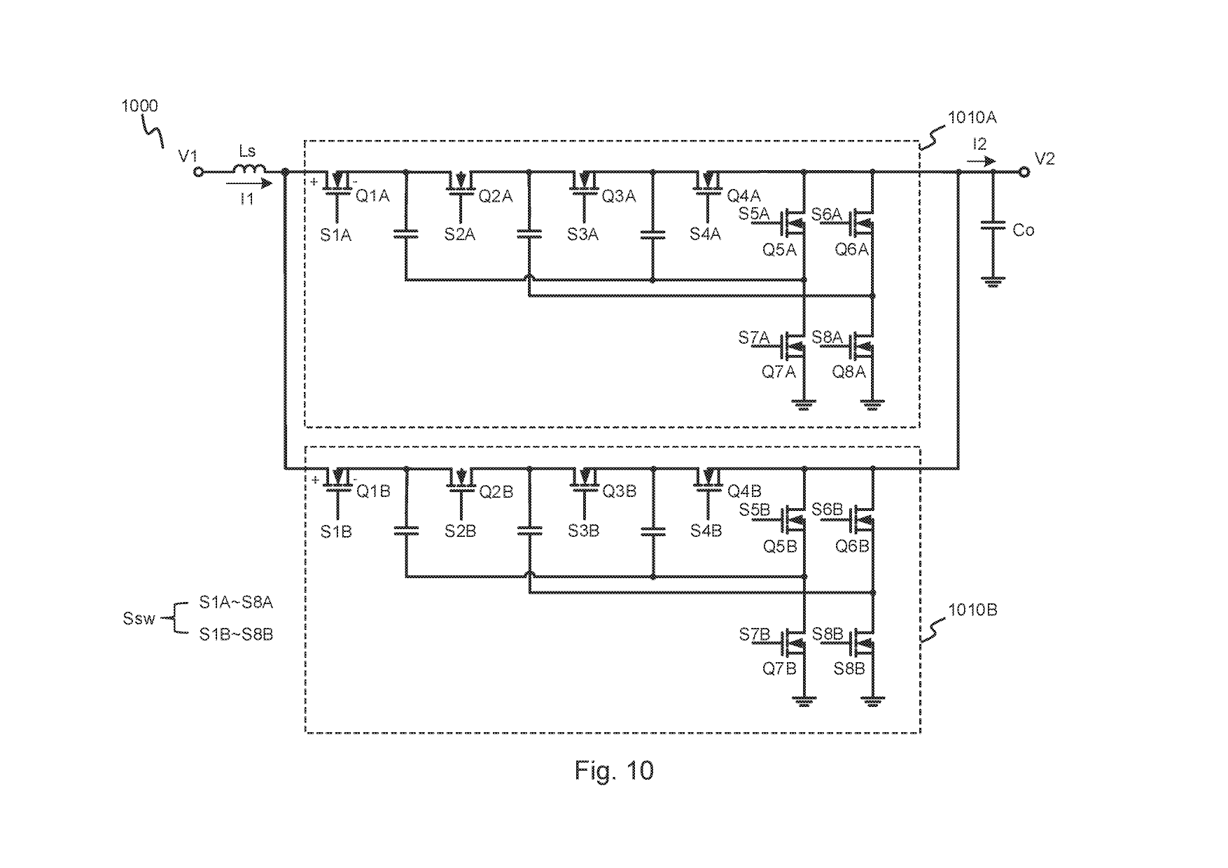

FIG. 10 illustrates the circuit configuration of a multi-phase switched capacitor converter 1000 in a Dickson architecture, having a voltage conversion ratio of 4:1, according to yet another embodiment of the present invention. This Dickson multi-phase switched capacitor converter 1000 also includes a first sub-converter 1010A and a second sub-converter 1010B connected in parallel between the first voltage V1 and the second voltage V2. Each sub-converter includes three flying capacitors (C1A–C3A, C1B–C3B) and a plurality of switches to implement a 4:1 voltage conversion ratio through progressive voltage division.

Similar to the previous embodiments, in FIGS. 8–10, the switching control signal Ssw controls the first and second sub-converters to alternately switch between a corresponding first switching phase (PH1A, PH1B) and a second switching phase (PH2A, PH2B), thereby achieving different electrical connections of the flying capacitors. In the corresponding first switching phase, at least one flying capacitor is electrically connected to the first voltage V1 to form a current path.

Moreover, at the system level, the switching control signal Ssw causes the multi-phase switched capacitor converters shown in FIGS. 8–10 to periodically switch between the first system state SSys1 and the second system state SSys2 via the overlapping system state SOlp. By these switching sequences, power conversion between the first voltage V1 and the second voltage V2 can be achieved while maintaining continuity of the first current I1, thereby effectively reducing ripple and spikes on the first voltage V1 and/or the second voltage V2, improving reliability, suppressing electromagnetic interference, and prolonging the lifespan of the components.

Furthermore, by applying an appropriate switch turn-on sequence within each switching phase, as described in the previous embodiments, and with the aid of either predetermined or detection-based delays, both zero-voltage switching and zero-current switching can be achieved during the switching phases to reduce switching loss.

In converters where each sub-converter includes multiple flying capacitors (e.g., as shown in FIGS. 8–10), a "selected flying capacitor" may be selected based on the "terminal-phase voltage difference" among the flying capacitors, and ZVS may be prioritized accordingly. The term "terminal-phase voltage difference" is defined as an absolute value of a voltage level difference at a given terminal of the flying capacitor between the first switching phase and the second switching phase, being electrically connected to corresponding nodes. This "terminal-phase voltage difference" serves as a basis for selecting the selected flying capacitor and the corresponding switches. The larger the terminal-phase voltage difference, the higher the risk of large instantaneous current and switching loss if the switch is directly turned on. Therefore, flying capacitors with larger terminal-phase voltage differences should be prioritized for ZVS operation.

In addition, when multiple flying capacitors exhibit similar terminal-phase voltage differences, the absolute values of the terminal voltage potentials may be further compared to determine the turn-on sequence. This ensures that voltage drops across switches follow a step-down pattern from high to low, thereby facilitating ZVS. In one embodiment, the lower voltage end of the flying capacitor may be switched first to be electrically connected to the corresponding node, allowing the higher voltage side to naturally discharge through the flying capacitor. The switch on the high-voltage side is subsequently turned on at an appropriate timing to achieve ZVS. Other flying capacitors are turned on sequentially in accordance with their voltage distribution, from low to high, forming a progressive voltage transition to further suppress current spikes and electromagnetic interference.

When switching from one connection mode to another (e.g., from series to parallel) between the first and second switching phases of each sub-converter, the present invention recommends beginning the new switching phase by turning on the node with the lowest potential among those originally connected in series. Voltage is thus gradually released until the high-voltage end is turned on last, thereby completing a smooth power transition. From one perspective, this turn-on sequence is the reverse of the sequence used when establishing the original series connection, ensuring that each switch is turned on during a decreasing voltage condition to achieve ZVS as much as possible.

Furthermore, under varying load current conditions, the present invention also considers the voltage deviation induced by current fluctuations in its control strategy. Even if voltage differences at terminals have been estimated in a steady-state condition, actual switching may be affected by variations due to the load. Therefore, the defined "terminal-phase voltage difference" can be dynamically evaluated and adjusted by the controller based on real-time measurement or prediction. This ensures that selected switches can still achieve near-optimal ZVS performance even under non-steady-state conditions.

In summary, the multi-phase switched capacitor converter of the present invention adopts a periodic transition mechanism involving an overlapping system state between the first and second system states during the interleaved switching of the first and second sub-converters. This scheme ensures that, during system transitions, at least one flying capacitor remains connected to the input voltage to maintain a current path, thereby effectively preventing voltage spikes caused by input current interruption. Moreover, through a sequential switching strategy applied in the first and second switching phases of each sub-converter, selected switches are turned on during a progressive voltage decreasing process, achieving ZVS and ZCS operations, significantly reducing switching losses and switch stress. As a result, the invention enhances conversion efficiency, suppresses EMI, and improves the overall stability and reliability of the power conversion system.

The present invention has been described in considerable detail with reference to certain embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A multi-phase switched capacitor converter configured to operably convert a first voltage to a second voltage or to convert the second voltage to the first voltage, comprising:
a first sub-converter and a second sub-converter, coupled in parallel between the first voltage and the second voltage;
wherein each of the first sub-converter and the second sub-converter includes:
a flying capacitor; and
a plurality of switches, configured to periodically switch electrical connections between the flying capacitor and the first and second voltages during a first switching phase and a second switching phase;
wherein during the first switching phase, the flying capacitor is electrically connected to the first voltage via switching of the plurality of switches, forming a current path; and during the second switching phase, the flying capacitor is electrically disconnected from the first voltage via the switching of the plurality of switches;
wherein the multi-phase switched capacitor converter periodically alternates between a first system state and a second system state to perform power conversion between the first voltage and the second voltage;
wherein in the first system state, the first sub-converter is in the first switching phase and the second sub-converter is in the second switching phase; in the second system state, the first sub-converter is in the second switching phase and the second sub-converter is in the first switching phase;
wherein a transition from the first system state to the second system state or from the second system state to the first system state includes an overlapping system state, such that a first current corresponding to the first voltage is maintained to avoid a voltage spike;
wherein in the overlapping system state, both the first sub-converter and the second sub-converter are in the first switching phase.

2. The multi-phase switched capacitor converter of claim 1, wherein a duration of the overlapping system state is less than 25% of a switching period of the multi-phase switched capacitor converter.

3. The multi-phase switched capacitor converter of claim 1,
wherein each of the first sub-converter and the second sub-converter is configured to transition from the first switching phase to the second switching phase, or from the second switching phase to the first switching phase, via a dead time.

4. The multi-phase switched capacitor converter of claim 1, wherein upon entering the first switching phase or the second switching phase, each of the first sub-converter and the second sub-converter is configured to switch a first terminal of the flying capacitor earlier than a second terminal of the flying capacitor to electrically connect the first terminal to a node corresponding to the first switching phase, such that the second terminal gradually approaches a zero-voltage state before being subsequently switched to electrically connect to a corresponding node in the first switching phase, thereby achieving zero-voltage switching (ZVS);
wherein under steady-state operation, a terminal of the flying capacitor having a lower voltage corresponds to the first terminal; and/or a terminal of the flying capacitor exhibiting a lower terminal-phase voltage difference corresponds to the first terminal;
wherein the terminal-phase voltage difference refers to an absolute value of a voltage level difference at each terminal of the flying capacitor between the first switching phase and the second switching phase.

5. The multi-phase switched capacitor converter of claim 4, wherein each of the first sub-converter and the second sub-converter includes a plurality of flying capacitors, wherein:
in the first switching phase, the plurality of flying capacitors sequentially complete corresponding electrical connections such that voltage transitions of both the first terminal and the second terminal of each of the plurality of flying capacitors increase progressively; and/or
in the second switching phase, the plurality of flying capacitors sequentially complete corresponding electrical connections such that voltage transitions of both the first terminal and the second terminal of each of the plurality of flying capacitors decrease progressively.

6. The multi-phase switched capacitor converter of claim 4,
wherein upon entering the first switching phase or the second switching phase, the first terminal of the flying capacitor is switched, via zero-current switching, to electrically connect to a corresponding node.

7. The multi-phase switched capacitor converter of claim 4,
wherein the plurality of switches includes a first switch, a second switch, a third switch, and a fourth switch, and wherein:
the first switch is coupled between the first voltage and the second terminal of the flying capacitor;
the second switch is coupled between a first terminal of the flying capacitor and the second voltage;
the third switch is coupled between the second terminal of the flying capacitor and the second voltage; and
the fourth switch is coupled between the first terminal of the flying capacitor and a ground potential;
wherein in the first switching phase, the first switch and the second switch are turned on to electrically connect the flying capacitor between the first voltage and the second voltage, such that the first voltage charges the flying capacitor and supplies power to the second voltage;
wherein in the second switching phase, the third switch and the fourth switch are turned on to electrically connect the flying capacitor in parallel with the second voltage, such that the flying capacitor discharges to supply power to the second voltage.

8. The multi-phase switched capacitor converter of claim 7,
wherein the first switch is turned on after a predetermined delay following the second switch being turned on to achieve zero-voltage switching; and/or
the third switch is turned on after a predetermined delay following the fourth switch being turned on to achieve zero-voltage switching;
or
wherein after the second switch is turned on, the first switch is turned on when a voltage across the first switch is below a threshold, to achieve zero-voltage switching; and/or
after the fourth switch is turned on, the third switch is turned on when a voltage across the third switch is below a threshold, to achieve zero-voltage switching.

9. The multi-phase switched capacitor converter of claim 7,
wherein a voltage conversion ratio between the first voltage and the second voltage is 2:1.

10. The multi-phase switched capacitor converter of claim 1,
wherein a voltage conversion ratio between the first voltage and the second voltage is K:1,
wherein each of the first sub-converter and the second sub-converter corresponds to a series-parallel switched capacitor converter comprising a plurality of flying capacitors, and K is a positive integer greater than or equal to 3.

11. The multi-phase switched capacitor converter of claim 1,
wherein a voltage conversion ratio between the first voltage and the second voltage is K:1,
wherein each of the first sub-converter and the second sub-converter corresponds to a pipelined switched capacitor converter or a Dickson switched capacitor converter, and K is a positive integer greater than or equal to 4.

12. The multi-phase switched capacitor converter of claim 1,
wherein an equivalent inductance is included between the first voltage and the flying capacitor, and the equivalent inductance causes the voltage spike when the first current is discontinued.

13. A control method for use in power conversion between a first voltage and a second voltage, comprising:
controlling each of two sub-converter units to periodically switch between a first switching phase and a second switching phase,
wherein during the first switching phase, a flying capacitor is electrically connected to the first voltage to form a current path toward the second voltage, and
during the second switching phase, the flying capacitor is disconnected from the first voltage;
controlling the two sub-converter units to periodically switch between a first system state and a second system state,
wherein the first system state corresponds to one of the two sub-converter units being in the first switching phase and the other one of the two sub-converter units being in the second switching phase, and
the second system state is inverse to the first system state; and
transitioning between the first system state and the second system state via an overlapping system state, during which both of the sub-converter units are in the first switching phase simultaneously, so as to maintain continuity of a first current corresponding to the first voltage to avoid a voltage spike.

14. The control method of claim 13,
wherein a duration of the overlapping system state is less than 25% of a switching period.

15. The control method of claim 13,
wherein the step of controlling each of the sub-converter units to periodically switch between the first switching phase and the second switching phase includes:
inserting a dead time between the first switching phase and the second switching phase for each of the sub-converter units, so as to prevent short-circuit current among switching elements within each of the sub-converter units.

16. The control method of claim 13,
wherein the step of controlling each of the sub-converter units to periodically switch between the first switching phase and the second switching phase includes:
upon entering the first switching phase, electrically connecting a first terminal of the flying capacitor to a corresponding node earlier than electrically connecting a second terminal of the flying capacitor to a corresponding node, such that the second terminal gradually approaches a zero-voltage state before being switched, thereby achieving zero-voltage switching (ZVS);
wherein under steady-state operation, a terminal of the flying capacitor having a lower voltage corresponds to the first terminal; and/or a terminal of the flying capacitor exhibiting a lower terminal-phase voltage difference corresponds to the first terminal;
wherein the terminal-phase voltage difference refers to an absolute value of a voltage level difference at each terminal of the flying capacitor between the first switching phase and the second switching phase.

17. The control method of claim 16, wherein each of the sub-converter units includes a plurality of flying capacitors, and
wherein the step of controlling each of the sub-converter units to periodically switch between the first switching phase and the second switching phase further includes:
in the first switching phase, sequentially completing corresponding electrical connections of the plurality of flying capacitors to corresponding nodes such that voltage transitions of both the first terminal and the second terminal of each of the plurality of flying capacitors increase progressively; and
in the second switching phase, completing corresponding electrical connections of the plurality of flying capacitors to corresponding nodes such that voltage transitions at the first and second terminals of each flying capacitor decrease progressively.

18. The control method of claim 17, wherein the first terminal of each of the plurality of flying capacitors is switched, via zero-current switching, to electrically connect to a corresponding node.
